(19) United States
(12) Patent Application Publication
(10) Pub. No.: US 2015/0091556 A1
(43) Pub. Date: Apr. 2, 2015

(54) METHOD AND APPARATUS FOR ANALYZING MATERIALS BY USING PATTERN ANALYSIS OF HARMONIC PEAKS

(71) Applicant: Electronics & Telecommunications Research Institute, Daejeon (KR)

(72) Inventors: Hyo Bong HONG, Daejeon-si (KR); Jae Ho Lim, Daejeon-si (KR); Sung Woong Shin, Daejeon-si (KR)

(73) Assignee: Electronics & Telecommunications Research Institute, Daejeon (KR)

(21) Appl. No.: 14/147,057

(22) Filed: Jan. 3, 2014

(30) Foreign Application Priority Data
Sep. 30, 2013 (KR) 10-2013-0116008

(51) Int. Cl. G01N 27/72

(52) U.S. Cl. CPC G01N 27/72
USPC 324/239

(57) ABSTRACT

The present invention provides an apparatus and a method for analyzing materials by using pattern analysis of harmonic peaks. The apparatus for analyzing materials according to the present invention comprises a generating unit generating two or more electromagnetic fields, a detecting unit detecting a magnetization signal generated from a measurement target material as an electromagnetic field is applied to the measurement target material, and an analyzing unit analyzing type of the measurement target material based on a harmonic pattern obtained from the magnetization signal.

This application claims the benefit of priority of Korean Patent Application No. 10-2013-0116008 filed on Sep. 30, 2013, which is incorporated by reference in its entirety herein.

### BACKGROUND OF THE INVENTION

1. Field of the Invention

The embodiments of the present invention are related to a method and an apparatus for analyzing behavior of a magnetic material inside a magnetic field.

2. Discussion of the Related Art

Paramagnetism refers to the behavior of a material which possesses magnetism when an external magnetic field is applied and loses the magnetism when the external magnetic field disappears. Therefore, paramagnetic materials are weakly magnetized along a direction of the surrounding magnetic field.

Today, research on biomaterials or diseases usually makes use of analysis of paramagnetic materials. However, analysis of paramagnetic materials conducted so far is limited only to check existence of the materials. Identifying the type of a paramagnetic material is also very important in analyzing the material. For most cases, equipment called EPR (Electro-Paramagnetic Resonance) or ESR (Electro-Spin Resonance) is used for analysis of paramagnetic materials.

As one example related to analysis of materials by using ESR, the Korean patent application no. 10-2010-0015625 (published on Feb. 12, 2010) “quantum theory-based continuous precision NMR/MRI: method and apparatus” discloses a method and an apparatus for applying MRI (Magnetic Resonance Imaging) and ESR scan, or NMR (Nuclear Magnetic Resonance) and MRI scan to a target material; pairing spin resonance radiated noise signals from the MRI and ESR scan, or NMR and MRI scan; removing noise by correlating the signals; and collecting signal data.

However, since analysis based on ESR or EPR requires a very strong electromagnet and involves sweeping high-frequency radio signals or magnetic forces, many limitations have to be worked around in order for the analysis based on ESR or EPR to be actually used in the field.

### SUMMARY OF THE INVENTION

An object of the present invention is to provide a method and an apparatus for analyzing materials whereby types of paramagnetic or super-paramagnetic materials can be determined in an easy manner without employing highly complicated and resource-devouring methods such as ESR (Electro Spin Resonance), SQUID (Superconducting Quantum Interference Device), and GMR (Great Magneto Resistive).

Another object of the present invention is to provide a method and an apparatus for analyzing materials whereby a two- or three-dimensionally distributed target material can be analyzed in addition to measuring the quantity or density of a product.

According to one aspect of the present invention, an apparatus for analyzing materials comprises a generating unit generating two or more electromagnetic fields, a detecting unit detecting a magnetization signal generated from a measurement target material as an electromagnetic field is applied to the measurement target material; and an analyzing unit analyzing type of the measurement target material based on a harmonic pattern obtained from the magnetization signal.

In one embodiment, the electromagnetic field is generated by applying two or more alternating currents of different frequencies respectively into an excitation coil.

In another embodiment, the measurement target material is a paramagnetic or a super-paramagnetic material.

In a yet another embodiment, the detecting unit detects the magnetization signal by using a detection coil made of coils having the same number of turns and winding directions opposite to each other and wound around both ends of a bobbin.

In a still another embodiment, the analyzing unit obtains harmonic peaks from the magnetization signal by using Fourier transform.

In a further embodiment, the analyzer analyzing unit the type of the measurement target material by comparing an RMS (Root-Mean-Square) value obtained through the pattern of harmonic peaks or coefficients calculated by converting the pattern of harmonic peaks into a high-order polynomial equation.

According to another aspect of the present invention, an apparatus for analyzing materials comprises two or more generators generating alternating currents of different frequencies; two or more excitation coils receiving the alternating currents and generating an electromagnetic field; a detection coil detecting a magnetized coil generated from a measurement target material as the electromagnetic field is applied to the measurement target material; and an analyzer analyzing the type of the measurement target material based on a harmonic pattern obtained from the magnetization signal.

According to a yet another aspect of the present invention, a method by which an apparatus for analyzing materials analyzes a measurement target material comprises generating two or more electromagnetic fields, applying the electromagnetic fields to a measurement target material, detecting a magnetization signal generated from the measurement target material as the electromagnetic field is applied to the measurement target material, and analyzing the type of the measurement target material based on a harmonic pattern obtained from the magnetization signal.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a block diagram illustrating an apparatus for analyzing materials according to one embodiment of the present invention;

FIG. 2 is a magnetization curve of a super-paramagnetic material;

FIG. 3 is a circuit diagram illustrating an apparatus for analyzing materials according to one embodiment of the present invention;

FIG. 4 is a circuit diagram illustrating a case where an apparatus for analyzing materials generates two electromagnetic fields according to one embodiment of the present invention; and

FIG. 5 is a flow diagram illustrating a method for analyzing materials according to one embodiment of the present invention.

### DETAILED DESCRIPTION OF THE INVENTION

In what follows, embodiments of the present invention will be described in detail with reference to appended drawings in order for those skilled in the art to which the present invention belongs to use the embodiments in an easy manner. However, the present invention can be embodied in various other forms, and is not limited to the embodiments described in this document. To describe the present invention without ambiguity, those parts irrelevant to the description have been omitted from the drawings, and similar drawing symbols are assigned to the elements similar to each other throughout the document.

Throughout the document, if a part is said to “include” a constituting element, it means that the part can further include other constituting elements rather than exclude the other constituting elements unless particularly described otherwise. Also, such a term as a “unit” indicates a unit that processes at least one function or operation, which can be embodied in the form of hardware or software, or a combination of hardware and software.

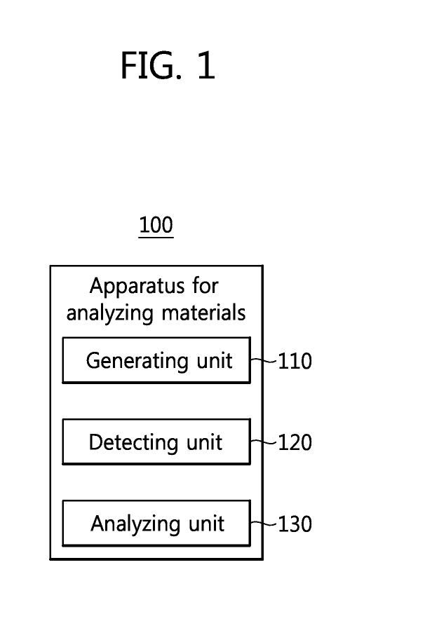

FIG. 1 is a block diagram illustrating an apparatus for analyzing materials according to one embodiment of the present invention.

With reference to FIG. 1, the apparatus for analyzing materials 100 comprises a generator 110, a detector 120, and an analyzer 130.

The generating unit 110, intended for generation an electromagnetic field to be applied to a measurement target material, generates two or more electromagnetic fields. To this purpose, the generating unit 110, for example, can generate two or more electromagnetic fields by applying two or more alternating currents of different frequencies respectively into an excitation coil.

The detecting unit 120 detects a magnetization signal generated from the measurement target material as the electromagnetic field generated by the generating unit 110 is applied to the measurement target material. As one example, the detecting unit 120 detects a magnetization signal generated from the measurement target material as the electromagnetic field is applied to the measurement target material by using a detection coil made of coils having the same number of turns and winding directions opposite to each other and wound around both ends of a bobbin. At this time, the measurement target material refers to a material which possesses magnetism when an external magnetic field is applied, where the material can be a paramagnetic or a super-paramagnetic material.

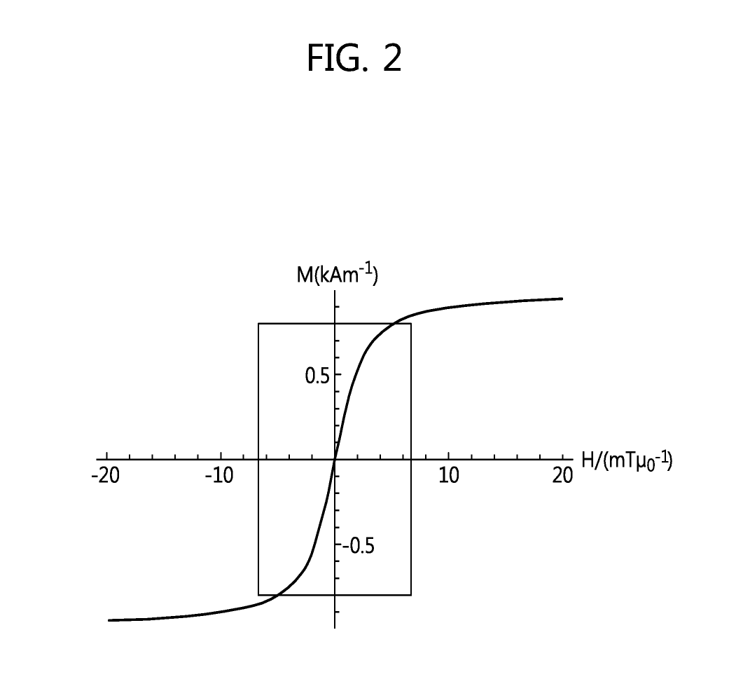

The analyzing unit 130 analyzes the type of a measurement target material based on harmonic patterns obtained from the magnetization signal detected by the detector 120. The analyzing unit 130 can obtain harmonic peaks from the magnetization signal by using Fourier transform. The analyzer analyzes the type of the measurement target material by comparing an RMS (Root-Mean-Square) value obtained through the pattern of harmonic peaks or coefficients calculated by converting the pattern of harmonic peaks into a high-order polynomial equation. In what follows, the apparatus for analyzing materials according to the present invention will be described in more detail with reference to FIGS. 2 to 4.

FIG. 2 is a magnetization curve of a super-paramagnetic material.

As shown in FIG. 2, a super-paramagnetic material has magnetization characteristics due to an external electromagnetic field. In FIG. 2, H represents a magnetic field while M represents magnetization. The relationship between H and M can be modeled by a probabilistic differential equation proposed by Paul Langevin as shown in Eq. 1.

$$M ( {μ}_{0} H ) = {M}_{S} \cdot ζ ( \frac{{m}_{0} {μ}_{0} H}{{K}_{B} T} ) , \qquad [ Eq . 1 ]$$

where the Langevin function is expressed as

$$ζ ( x ) = coth ( x ) - \frac{1}{x} ,$$

and x represents a dimensionless magnetic field. μ₀ represents vacuum permeability, which is 4π×10⁻⁷ Vs/AM, and m₀ represents a magnetic moment.

Therefore, in case two different frequency radio waves are used at the same time for excitation, the super-paramagnetic material reveals a change of magnetization as shown in Eq. 2.

$${μ}_{0} H ( t ) = {B}_{0} [ {A}_{0} + {A}_{1} sin ( 2 π {f}_{1 t} ) + {A}_{2} sin ( 2 π {f}_{2 t} ) ] \\ M ( t ) = {M}_{S} \cdot ζ ( \frac{{m}_{0} - {B}_{0} [ {A}_{0} + {A}_{1} sin ( 2 π {f}_{1 t} ) + {A}_{2} sin ( 2 π {f}_{2 t} ) ]}{{K}_{B} T} ) . \qquad [ Eq . 2 ]$$

Then the conductor obtains a signal induced by magnetization according to Faraday's law of induction as shown in Eq. 3.

$$∇ \times E = - \frac{δ B}{δ t} \\ B = {μ}_{0} ( H + M ) \qquad [ Eq . 3 ]$$

E=Electric Field Strength

B=Magnetic Flux Density

$${∮}_{BS} E ( l ) \cdot d l = - \frac{d }{d t} {Φ}_{S}^{B}$$

$$S = surface$$

$${Φ}_{S}^{B} = {\int }_{S}^{ } B ( r ) \cdot d A$$

Intergration of the electric field strength along the conductor

$$u ( t ) = {∮}_{as} E ( l , t ) \cdot d l . \\ u ( t ) = - \frac{d }{d x} {Φ}_{S}^{B} ( t )$$

$$u ( t ) = - \frac{d }{d x} {\int }_{S}^{ } B ( r , t ) \cdot d A$$

$$\begin{matrix}{u}^{p} ( t ) = - {μ}_{0} \frac{d }{d x} {\int }_{object}^{ } {\int }_{object}^{ } {p}^{R} ( r ) \cdot M ( r , t ) {d}^{3} \cdot M ( r , t ) {d}^{3} \\ = - {μ}_{0} {\int }_{object}^{ } {p}^{R} ( r ) \cdot \frac{ d M ( r , t )}{d x} {d}^{3} r\end{matrix}$$

$${P}^{R} ( r ) = ‖ {P}^{R} ( r ) ‖ = \frac{{H}^{R} ( r )}{{I}^{R}}$$

Therefore, inside the detection coil, generated are 1) a radio wave at an excitation frequency f1, 2) a radio wave at an excitation frequency f2, 3) a signal induced by magnetization according to Faraday's law of induction, and 4) harmonic peaks generated when magnetization modulates an electromagnetic field. In practice, a signal in a highly complicated form is generated, but if data obtained in the frequency domain rather than the time domain, various types of peaks can be generated.

In other words, if a paramagnetic or a super-paramagnetic material is exposed to an electromagnetic field having two different frequencies, a nonlinear magnetization signal is generated as shown in Eq. 4.

H=A1 Sin [2Pif1x]+A2 Sin [2Pif2x]+Ms(Coth[(m0u0H)/1.380643·10\hat{—}−23300]−1.380643·10\hat{—}—23 300/(m0u0H)); [Eq. 4]

When the Fourier transform is applied to Eq. 4, harmonic peaks can be obtained; generated harmonic peaks have a different pattern depending on MS (Magnetic Saturation) and m₀ (magnetic moment) value, which is a unique physical property of a paramagnetic or a super-paramagnetic material. Therefore, the apparatus for analyzing materials according to the present invention can analyze magnetic beads by analyzing the pattern of harmonic peaks, or can analyze and measure the type of a paramagnetic or a super-paramagnetic material.

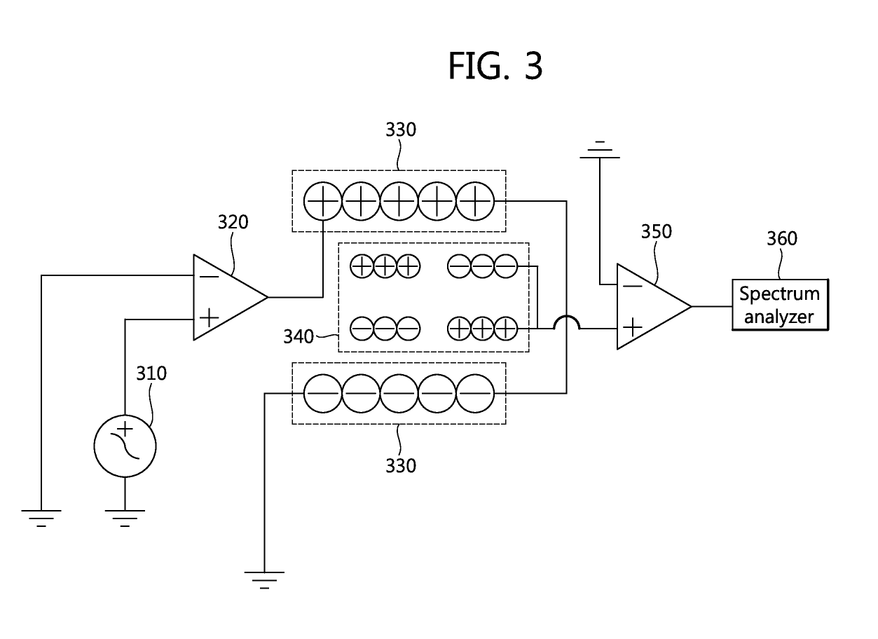

FIG. 3 is a circuit diagram illustrating an apparatus for analyzing materials according to one embodiment of the present invention.

With reference to FIG. 3, the apparatus for analyzing materials comprises a generator 310 generating alternating current, a current amplifier 320 amplifying alternating currents generated by the generator 310, an excitation coil 330 receiving amplified alternating currents and generating an electromagnetic field, a detection coil 340 detecting a magnetization signal generated from a measurement target material as the electromagnetic field generated by the excitation coil is applied to the measurement target material, and a spectrum analyzer 360 for analyzing the type of the measurement target material based on harmonic patterns obtained from the magnetization signal detected by the detection coil 340.

The generator 310 can be a function generator, for example. The generator can be connected to the excitation coil by soldering. However, in case amplitude of a signal is small, the current amplifier may be used as shown in FIG. 3.

The excitation coil 330 may be a primary coil which can apply the electromagnetic field to a measurement target material or a secondary coil for generating a carrier signal. The detection coil 340, which is similar to the solenoid coil, may be made of coils having the same number of turns and winding directions opposite to each other and wound around both ends of a bobbin. As shown in FIG. 3, “+” and “−” symbol marked respectively for the excitation coil 330 and the detection coil 340 represent winding directions.

The spectrum analyzer 360 obtains the pattern of harmonic peaks, which actually is a frequency data obtained by discretizing the magnetization signal, by using the Fourier transform. The spectrum analyzer 360 can analyze the type of the measurement target material by comparing an RMS (Root-Mean-Square) value obtained through the pattern of harmonic peaks or coefficients calculated by converting the pattern of harmonic peaks into a high-order polynomial equation.

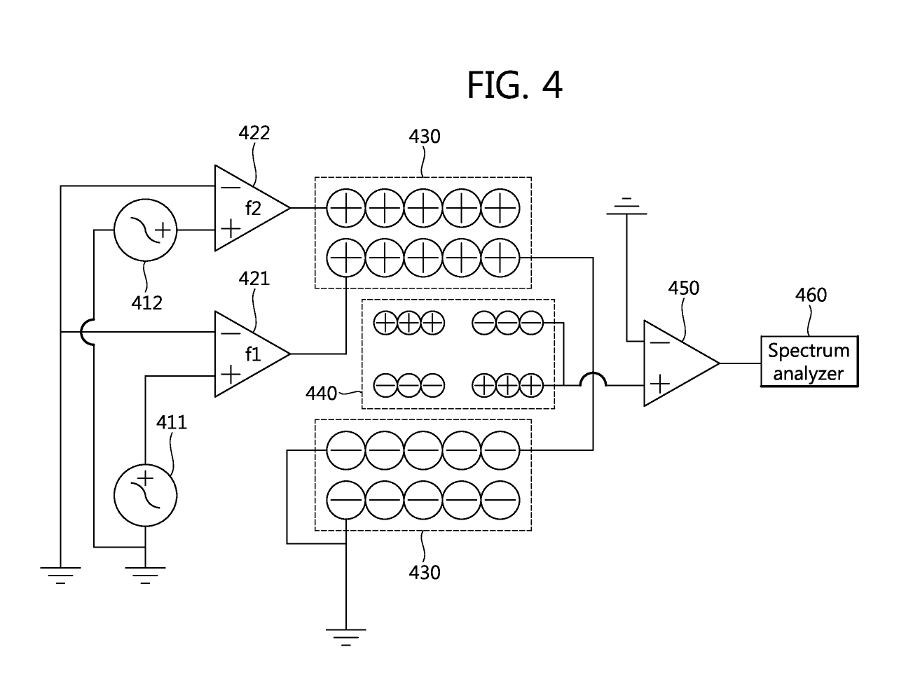

FIG. 4 is a circuit diagram illustrating a case where an apparatus for analyzing materials generates two electromagnetic fields according to one embodiment of the present invention.

In this case, the apparatus for analyzing materials according to the present invention comprises two or more generators 411, 412 generating alternating currents of different frequencies, f1 and f2. Each generator 411, 412 can be connected respectively to the current amplifier 421, 422 for signal amplification as shown in FIG. 4. The alternating current generated by each generator 411, 412 is input to the excitation coil 430 intended for generating an electromagnetic field.

The detection coil 440 detects a magnetization signal generated from a measurement target material as the electromagnetic field generated by the excitation coil 430 is applied to the measurement target material. The magnetization signal detected by the detection coil 440 is amplified by the current amplifier 450, and the spectrum analyzer 460 obtains a harmonic pattern from the magnetization signal. The obtained harmonic pattern can be accumulated in a network or a database (DB), and can be used for providing knowledge-based services afterwards.

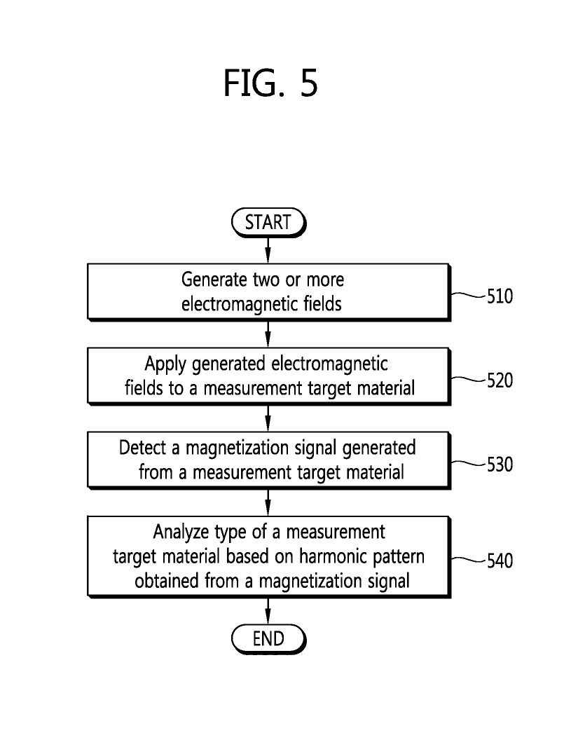

FIG. 5 is a flow diagram illustrating a method for analyzing materials according to one embodiment of the present invention.

First, the apparatus for analyzing materials according to the present invention generates two or more electromagnetic fields for analyzing a paramagnetic or a super-paramagnetic material 510. To this purpose, the apparatus for analyzing materials generates an electromagnetic field by applying two or more alternating currents of different frequencies respectively to an excitation coil. Here, the excitation coil may be a primary coil which can apply the electromagnetic field to a measurement target material or a secondary coil for generating a carrier signal.

Once a measurement target material is put at a measurement position, the apparatus for analyzing materials applies an electromagnetic field to the measurement target material 520 and detects a magnetization signal generated from the measurement target material by using the detection coil as the electromagnetic field is applied to the measurement target material 530. At this time, the detection coil may be made of coils having the same number of turns and winding directions opposite to each other and wound around both ends of a bobbin. The detected magnetization signal can be amplified by the current amplifier.

Next, the apparatus for analyzing materials analyzes the type of the measurement target material based on harmonic pattern obtained from the magnetization signal 540. As one example, the apparatus for analyzing materials obtains harmonic peaks from the magnetization signal through FFT (Fast Fourier Transform) and analyzes the type of the measurement target material by comparing an RMS (Root-Mean-Square) value obtained through the harmonic pattern or coefficients calculated by converting the harmonic pattern into a high-order polynomial equation.

Embodiments above are provided to illustrate the technical principles of the present invention; thus, it should be understood that those skilled in the art to which the present invention belongs will be able to change or modify the embodiments in various other ways unless changes or modifications of the embodiments depart from the inherent characteristics of the present invention. Therefore, those embodiments disclosed in this document are not intended to limit the technical principles of the present invention but to describe the technical principles; and the technical scope of the present invention is not limited by those embodiments. The technical scope of the present invention should be interpreted by the appended claims and all the technical principles belonging to the scope equivalent to that defined by the claims should be understood to be included in the claimed scope of the present invention.

The present invention estimates a relationship between a sensory effect and an emotional response by using emotional inference determining an emotional response of a user to a sensory effect stimulus based on a compound emotional signal obtained by sensing a user's motion, facial expression, voice, biometric signal, and so on, thereby automatically playing sensory media for the user to experience satisfaction continuously.

An apparatus for analyzing materials according to the present invention can have a very simple structure since harmonic patterns are employed instead of resonance as in EPR (Electro Paramagnetic Resonance) or ESR (Electro Spin Resonance), and can analyze the type of a material without employing a strong magnet or high frequency radio waves.

Since the present invention does not require sweeping time, analysis time can be significantly reduced, and a chemical reaction occurred at one spot or a group of magnetic particles can be measured in real-time.

By analyzing harmonic patterns, a quantitative and a qualitative analysis can be performed at the same time.

What is claimed is:

1. An apparatus for analyzing materials, comprising:
a generating unit generating two or more electromagnetic fields;
a detecting unit detecting a magnetization signal generated from a measurement target material as an electromagnetic field is applied to the measurement target material; and
an analyzing unit analyzing type of the measurement target material based on a harmonic pattern obtained from the magnetization signal.

2. The apparatus of claim 1, wherein the electromagnetic field is generated by applying two or more alternating currents of different frequencies respectively into an excitation coil.

3. The apparatus of claim 1, wherein the measurement target material is a paramagnetic or a super-paramagnetic material.

4. The apparatus of claim 1, wherein the detecting unit detects the magnetization signal by using a detection coil made of coils having the same number of turns and winding directions opposite to each other and wound around both ends of a bobbin.

5. The apparatus of claim 1, wherein the analyzing unit obtains harmonic peaks from the magnetization signal by using Fourier transform.

6. The apparatus of claim 1, wherein the analyzing unit analyzes type of the measurement target material by comparing an RMS (Root-Mean-Square) value obtained through the harmonic pattern or coefficients calculated by converting the harmonic pattern into a high-order polynomial equation.

7. An apparatus for analyzing materials, comprising:
two or more generators generating alternating currents of different frequencies;
two or more excitation coils receiving the alternating currents and generating an electromagnetic field;
a detection coil detecting a magnetized coil generated from a measurement target material as the electromagnetic field is applied to the measurement target material; and
an analyzer analyzing the type of the measurement target material based on a harmonic pattern obtained from the magnetization signal.

8. The apparatus of claim 7, wherein the measurement target material is a paramagnetic or a super-paramagnetic material.

9. The apparatus of claim 7, further comprising an amplifier amplifying at least one of the alternating current and the magnetization signal.

10. The apparatus of claim 7, wherein the excitation coil is a primary coil applying the electromagnetic field to the measurement target material or a secondary coil generating a carrier wave signal.

11. The apparatus of claim 7, wherein the detection coil is made of coils having the same number of turns and winding directions opposite to each other and wound around both ends of a bobbin.

12. The apparatus of claim 7, wherein the analyzer obtains harmonic peaks from the magnetization signal by using Fourier transform.

13. The apparatus of claim 7, wherein the analyzer analyzes type of the measurement target material by comparing an RMS (Root-Mean-Square) value obtained through the harmonic pattern or coefficients calculated by converting the harmonic pattern into a high-order polynomial equation.

14. In a method by which an apparatus for analyzing materials analyzes a measurement target material, a method for analyzing materials, comprising:
generating two or more electromagnetic fields;
applying the electromagnetic fields to a measurement target material;
detecting a magnetization signal generated from the measurement target material as the electromagnetic field is applied to the measurement target material; and
analyzing type of the measurement target material based on a harmonic pattern obtained from the magnetization signal.

15. The method of claim 14, wherein the electromagnetic field is generated by applying two or more alternating currents of different frequencies respectively into an excitation coil.

16. The method of claim 15, wherein the excitation coil is a primary coil applying the electromagnetic field to the measurement target material or a secondary coil generating a carrier wave signal.

17. The method of claim 14, wherein the measurement target material is a paramagnetic or a super-paramagnetic material.

18. The method of claim 14, wherein the detecting detects the magnetization signal by using a detection coil made of coils having the same number of turns and winding directions opposite to each other and wound around both ends of a bobbin.

19. The method of claim 14, wherein the analyzing comprises
obtaining harmonic peaks from the magnetization signal by using Fourier transform; and
analyzing type of the measurement target material by comparing an RMS (Root-Mean-Square) value obtained through the harmonic pattern or coefficients calculated by converting the harmonic pattern into a high-order polynomial equation.

20. The method of claim 14, further comprising amplifying the magnetization signal after the detecting.
